(19) United States
(12) Patent Application Publication
(10) Pub. No.: US 2013/0193712 A1
(43) Pub. Date: Aug. 1, 2013

(54) AUXILIARY SIDE WINDOW VISOR WITH SEE-THROUGH GLARE SHIELD

(71) Applicant: Jonathan P. Marcus, Holland, MI (US)

(72) Inventor: Jonathan P. Marcus, Holland, MI (US)

(73) Assignee: Marcus Automotive, LLC, Holland, MI (US)

(21) Appl. No.: 13/752,855

(22) Filed: Jan. 29, 2013

Related U.S. Application Data
(60) Provisional application No. 61/592,060, filed on Jan. 30, 2012.

(51) Int. Cl. B60J 3/02

(52) U.S. Cl. CPC B60J 3/0204
USPC 296/97.3

(57) ABSTRACT

A side window visor can be moved from a stored position to a side window position and includes a body framing a transparent window made of a tinted, polarized, micro-louver, phototropic or electro-optical material, such that, when the visor is moved to a side window position, the driver still has visibility through the window of the visor while simultaneously receiving significant sun-blocking protection. The visor can be an auxiliary visor working in cooperation with a nested visor system to provide the desired sun protection while providing peripheral visibility to the operator.

### CROSS-REFERENCE TO RELATED APPLICATIONS

This application claims priority under 35 U.S.C. §119(e) and the benefit of U.S. Provisional Application No. 61/592,060 entitled AUXILIARY SIDE WINDOW VISOR WITH SEE-THROUGH GLARE SHIELD, filed on Jan. 30, 2012, by Jonathan P. Marcus, the entire disclosure of which is incorporated herein by reference.

### BACKGROUND OF THE INVENTION

The present invention relates to vehicle sun visors and particularly to a visor which can be moved to the side window and has a see-through window.

Conventional vehicle visors are typically rotated down from a stored position against the headliner and can be released from the front window position and moved to a side window position providing sun blocking protection from the side. Although it is frequently desirable to have sun blocking from the side window panel, a totally opaque visor panel also blocks the driver's peripheral vision on the side. In urban traffic settings, it may be desirable to be able to observe activities on the side of the vehicle as much as possible while still preventing entry of bright sunlight.

### SUMMARY OF THE INVENTION

The present invention solves this dilemma by providing a visor which can be moved from a stored position to a side window position and includes a body framing a transparent window made of a tinted, polarized, micro-louver, phototropic, or electro-optical material, such that, when the visor is moved to a side window position, the driver still has visibility through the window of the visor while simultaneously receiving significant sun-blocking protection. The visor can be a single visor or an auxiliary visor working in cooperation with a nested visor system to provide the desired sun protection while providing peripheral visibility to the operator.

These and other features, objects and advantages of the present invention will become apparent upon reading the following description thereof together with reference to the accompanying drawings.

### BRIEF DESCRIPTION OF THE DRAWINGS

FIG. 1 is a perspective view of a visor system including a side window visor of the present invention shown being released from the primary visor;

FIG. 2 is a perspective view illustrating the subsequent progressive motion of the side window visor from the front window position;

FIG. 3 is a perspective view showing the further advancement of the preferred embodiment of the side window visor toward a side window position;

FIG. 4 is a perspective view showing the advancement of the side window visor to the side window position;

FIG. 5 is a perspective view showing the final movement of the side window visor to a raised side window position;

FIG. 6 is a perspective view illustrating the see-through capabilities of the tinted window included in the side window visor; and

FIG. 7 is an exploded perspective view of the pivot mounting structure of the side window visor.

### DETAILED DESCRIPTION OF THE PREFERRED EMBODIMENT

Referring to the drawing figures, there is shown a vehicle 10, such as an automobile, SUV, truck or the like, which includes a roof with a headliner 12 above the windshield 14 and an A-pillar 13 separating the windshield 14 from the side window 16. The vehicle includes a visor system 30 which can be of the type described in U.S. patent application Ser. No. 13/633,309, entitled ROTATABLE SIDE WINDOW VISOR AND GLARE SHIELD, filed on Oct. 2, 2012, or, alternately, it can be of the type disclosed in PCT Application WO 2011/133791 entitled VISOR WITH PIVOTED SIDE WINDOW PANEL and filed on Apr. 21, 2011, the disclosures of both of these applications are incorporated herein by reference.

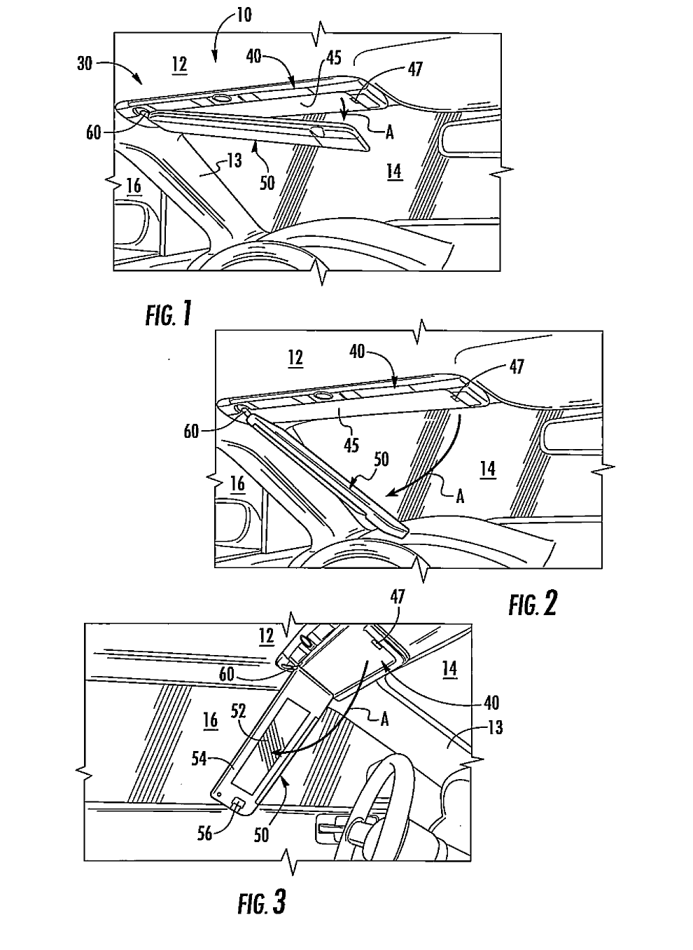

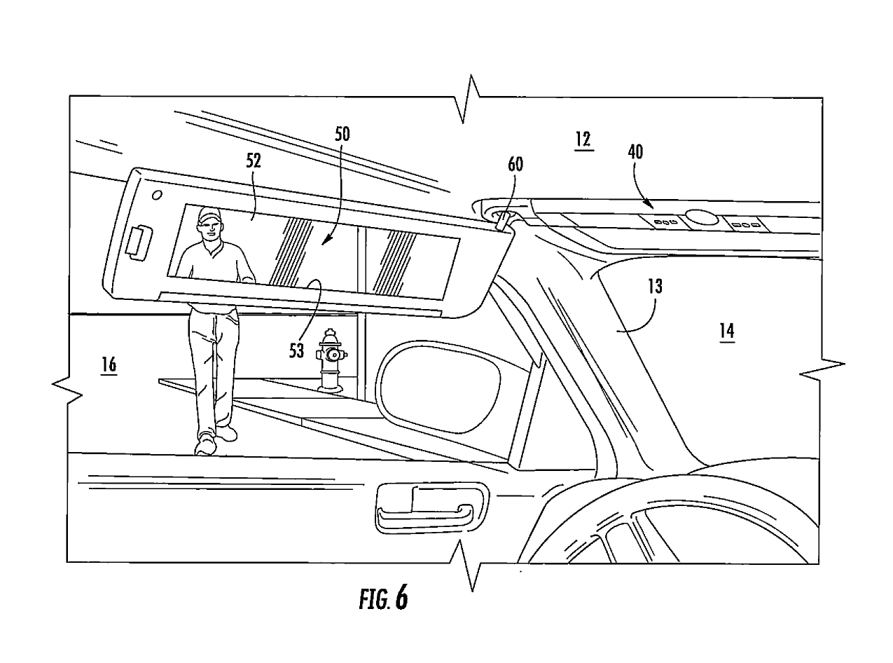

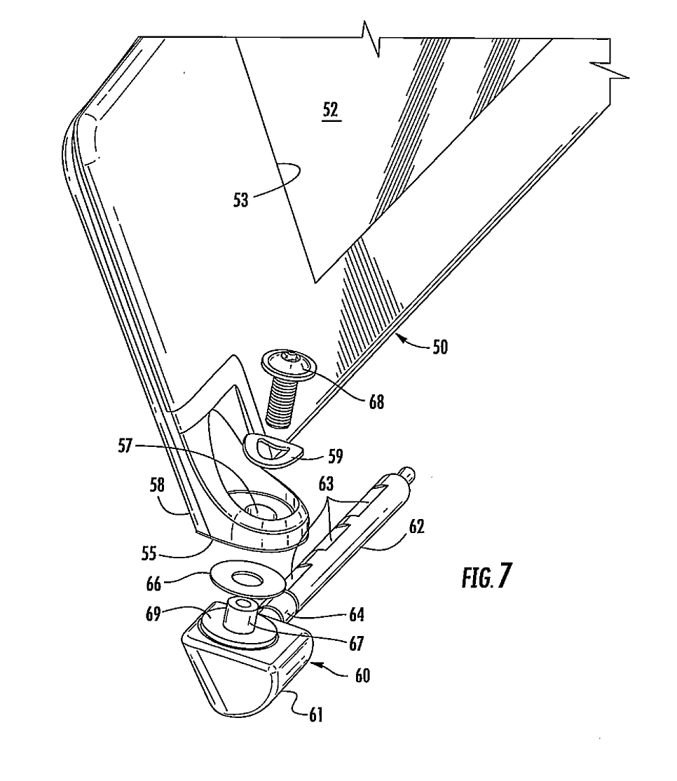

The visor system includes a primary visor 40 which is hinged to tilt downwardly away from the windshield toward the driver when lowered and a side window visor 50 which can be nested within the pocket 45 of the primary visor 40 or released, as illustrated in FIGS. 1-5, for movement, as shown by arrow A in these figures to a position toward the side window 16, as shown in FIGS. 5 and 6, adjacent the upper edge of side window 16 and near the headliner 12. The pivot mechanism for the side window visor 50, as well as the primary visor 40, is shown in FIG. 7.

The primary visor 40 is made of a resilient polymeric material, such as ABS, and includes a socket 47 in the upper right corner (FIGS. 1-3), which receives a snap-in post 56 (FIG. 3) on the side window visor 50. The side window visor can thus be released from the primary visor as shown in FIGS. 1-6 for movement to the vehicle's side window 16. The side window visor 50 is pivotally coupled to a pivot mounting assembly 60 (best seen in FIG. 7), which includes a pivot rod 62 fixedly secured to a knuckle 61 of assembly 60. Pivot rod 62 extends into the vehicle roof support structure and is rotatably mounted therein under the control of a torque spring. Pivot rod 62 is supported at the knuckle end by a bushing 64. The rod 62 also has flats 63 which are engaged by the fingers of a torque spring secured to the header of the vehicle roof structure.

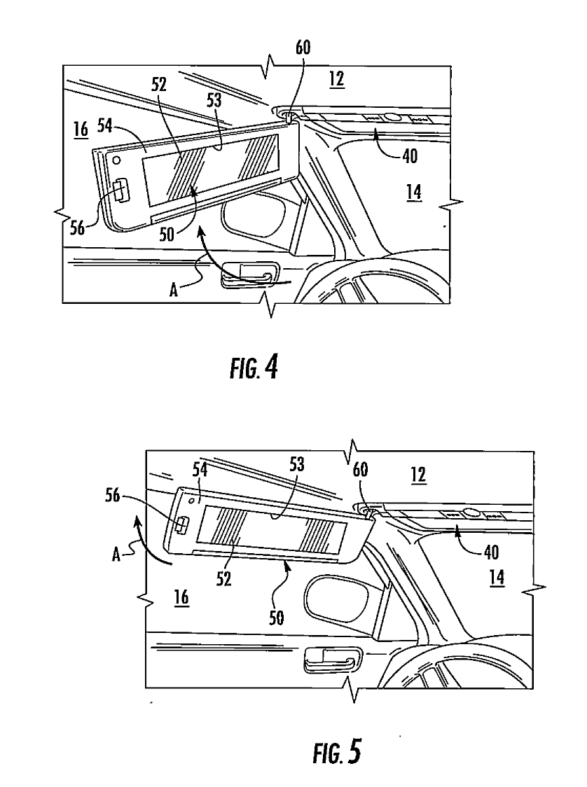

The side window visor 50 includes an angled bracket 58 (FIG. 7), which is angled to provide a mounting surface 55 which engages angled knuckle surface 69. The knuckle 61 is pivotally coupled to visor 50 by a second pivot connection including a mounting bolt 68 extending through aperture 57 in bracket 58. Bolt 68 extends through a thrust washer 59, a friction washer 66, and is threaded into hollow internally threaded pivot rod 67 providing a pivot connection for visor 50 with respect to knuckle 61. Pivot rod 67 is orthogonal to the axis of pivot rod 62. The rotational interface between visor 50 and knuckle 61 is the aperture 57 in bracket 58 and the outer surface of pivot axle 67. When the pivot knuckle 61 is attached to the header of the vehicle roof with pivot rod 62, the two axis pivot arrangement allows the side window visor 40 to dip downwardly in the sequence illustrated in FIGS. 1-5 as the visor is moved from the stowed position to a side window position (shown in FIGS. 5 and 6). This occurs due to the initial rotation of the knuckle 61 and rod 62 in the vehicle roof structure as the side window visor 50 is initially released from the primary visor 40. As seen in FIGS. 2-5, it dips downwardly out of the head space area of the user. Subsequently, as the user moves the visor toward the side window, the knuckle 61 rotates on pivot rod 62 to move the visor upwardly and toward the side window position illustrated in FIGS. 5 and 6. The mating surfaces 55 of bracket 58 and surface 69 of knuckle 61 incline visor 50 toward the side window 16 at about 20° to keep it away from the side of the driver's face when it is in the detented side window position shown in FIG. 6 and allows the driver to see through the window 52 in the sun visor 50.

Side window visor 50 is unique in that it includes a window 52 surrounded by the visor body frame 54 which is hingedly coupled to the headliner roof by the pivot mounting assembly 60. The frame 54 supports the see-through window 52, which occupies the major area of the side window visor surface, such that, as seen in FIG. 6, visibility of objects outside the side window of the vehicle is provided. Window 52 can be made of any transparent, glare-reducing material and is typically made of a polymeric material, although it can be a laminate of several layers of polymeric material with different glare-reducing properties. Thus, the window 52 can be made of a tinted, transparent material, micro-louver material, polarized material, phototropic material, or electrically controlled variable density material, such that the opacity can be selectively controlled.

The visor 50 can otherwise be of conventional construction with frame 54 being made of, for example, a polymeric body with suitably upholstered exterior surface to conform the appearance of visor 50 to that of the interior of the vehicle 10. The window 52 is held within the frame 54 by conventional means such as sandwiching the edges of the window between two layers of material making up the frame 54 of visor 50. The edges 53 of the interface between window 52 and frame 54 are trimmed to provide a finished appearance to the visor 50. Thus, with the visor system of the present invention, the user is provided with a side window visor having sun-blocking properties sufficient to prevent unwanted glare and yet provide visibility through the visor to be able to see potentially important activity laterally of the vehicle.

It will become apparent to those skilled in the art that various modifications to the preferred embodiment of the invention as described herein can be made without departing from the spirit or scope of the invention as defined by the appended claims.

The invention claimed is:

1. A vehicle visor comprising:
a visor body movably mounted to the vehicle such that it can be moved from a stored position adjacent a vehicle headliner to a use position over at least part of a side window for providing supplemental sun screening, said body having a transparent glare screening window permitting visibility through said visor.

2. The visor as defined in claim 1 wherein said body defines a generally rectangular frame for said window.

3. The visor as defined in claim 2 wherein said window is made of one of tinted, polarized, micro-louver, phototropic, or electrically controlled material.

4. The visor as defined in claim 3 wherein said visor body is mounted to the vehicle such that it can be moved to a side window position without encroaching in a user's space.

5. A visor system for a vehicle including a primary visor having a body and mount to allow said visor body to be attached to a vehicle for pivotal movement from a raised stored position rearwardly toward the user to a lowered use position; and
an auxiliary visor panel including a pivotal mount for pivotally mounting the auxiliary visor panel to a vehicle for pivoting to a side window position without encroaching in a user's space, said auxiliary visor panel including a see-through window.

6. The visor system as defined in claim 5 wherein said primary visor includes a recess for receiving said auxiliary visor.

7. The visor system as defined in claim 5 wherein said auxiliary visor is pivotally mounted to a vehicle roof such that it can pivot downwardly and away from the primary visor without encroaching in the user's space.

8. The visor system as defined in claim 5 wherein said auxiliary visor panel defines a generally rectangular frame for said window.

9. The visor system as defined in claim 8 wherein said window is made of one of tinted, polarized, micro-louver, phototropic, or electrically controlled material.

10. A visor system for a vehicle comprising:
a primary visor;
a mount coupled to said primary visor and attached to a vehicle allowing said visor to rotate from a raised stored position away from the windshield toward the user to lowered use positions; and
a side window visor including a dual axis pivotal mount coupled to said mount for pivotally mounting said side window visor to a vehicle for pivoting downwardly and laterally to a side window position without encroaching in a user's space, said side window visor having a glare screen window.

11. The visor system as defined in claim 10 wherein said side window visor has a body which defines a frame for said window rotatably coupled to said header.

12. The visor system as defined in claim 11 wherein said window is made of one of tinted, polarized, micro-louver, phototropic, or electrically controlled material.

13. The visor system as defined in claim 12 wherein said dual axis mount includes a pivot knuckle and a pivot rod extending from said pivot knuckle and wherein said side window visor is pivotally coupled to said knuckle.

14. The visor system as defined in claim 13 wherein the axis of rotation of said side window visor with respect to said knuckle is substantially orthogonal to the longitudinal axis of said pivot rod.

15. The visor system as defined in claim 14 and further including a detent spring for engaging said pivot rod for holding said side window visor in predetermined positions.
